(19) United States
(12) Patent Application Publication
(10) Pub. No.: US 2022/0383202 A1
(43) Pub. Date: Dec. 1, 2022

(54) EVALUATING A CONTRIBUTION OF PARTICIPANTS IN FEDERATED LEARNING

(71) Applicant: International Business Machines Corporation, Armonk, NY (US)

(72) Inventors: Lei Yu, Sleepy Hollow, NY (US); Qi Zhang, West Harrison, NY (US); Petr Novotny, Mount Kisco, NY (US)

(21) Appl. No.: 17/331,067

(22) Filed: May 26, 2021

(51) Int. Cl. G06N 20/20

(52) U.S. Cl. CPC G06N 20/20

(57) ABSTRACT

A contribution evaluation method, system, and computer program product that evaluates the contribution of each participant-computing device in the federated learning scheme based upon the quality of model updates received from the participant, measured by the accuracy improvement of FL model with applying the participant's model updates.

### BACKGROUND

The present invention relates generally to a contribution evaluation method, and more particularly, but not by way of limitation, to a system, method, and computer program product to evaluate the contribution of participants in federated learning.

Federated learning (FL) enables multiple participants (also referred to as a “client(s)”) to build a common, robust machine learning model without sharing data, thus allowing it to address critical issues such as data privacy, data security, data access rights and access to heterogeneous data.

Conventionally, an evaluation of a contribution of a participant(s) in federated learning includes independent scores where each participant independently trains a model and evaluates the model. The independent scores indicate a level of participation of each participant. Each participant may not participate in every round of modeling and the model accuracy improvement is different during different phases of training.

These conventional techniques use Shapley value-based methods where the participants compute a data point-wise Shapley value. Only a data-wise valuation is used where each client may devote different computation costs (i.e., iterations) for the update in the federated learning to produce better updates. However, this has a high computation cost that requires model retraining with random data permutation sampling (i.e., most have number clients' times training).

This limits the practicality of the conventional techniques for deep neural network (DNN) training. And, one cannot apply the conventional techniques to decentralized training setting of federated learning such that there are no global data permutations and dynamic client updates. Currently, there is no systematic method for measuring the contribution of participants in federated learning.

Thereby, there is a problem in the art that profits are not properly allocated to different participants across different phases, because the different phases require different amounts of contribution due to the lack of time-based approaches.

### SUMMARY

Thus, the inventors have considered a technical solution to the technical problem in the conventional techniques by making a global parameter (e.g., central) server perform profiling of clients' contributions during a training process or after training with recording all historical updates from clients. A temporal-aware allocation in this improvement divides the training time into different durations, decides the profit allocation policy among different durations, computes the contribution score of a client in each duration, and sums the contribution scores of different durations for each client.

In an exemplary embodiment, the present invention can provide a computer-implemented optimization method, the method including providing access to a test data set for a participant-computing device in a federated learning scheme and evaluating a contribution of the participant-computing device in the federated learning scheme based upon usage of the test data.

In an alternative exemplary embodiment, the present invention can provide a contribution evaluation computer program product, the contribution evaluation computer program product comprising a computer-readable storage medium having program instructions embodied therewith, the program instructions executable by a computer to cause the computer to perform providing access to an initial model parameter and a training plan for a participant computing device in a federated learning scheme and evaluating a contribution of the participant-computing device in the federated learning scheme based upon usage of the training data in the training plan.

In another exemplary embodiment, the present invention can provide a contribution evaluation system, said system including a processor and a memory, the memory storing instructions to cause the processor to perform providing access to an initial model parameter and a training plan for a participant computing device in a federated learning scheme and evaluating a contribution of the participant-computing device in the federated learning scheme based upon usage of the training data in the training plan.

Other details and embodiments of the invention will be described below, so that the present contribution to the art can be better appreciated. Nonetheless, the invention is not limited in its application to such details, phraseology, terminology, illustrations and/or arrangements set forth in the description or shown in the drawings.

Rather, the invention is capable of embodiments in addition to those described and of being practiced and carried out in various ways and should not be regarded as limiting.

As such, those skilled in the art will appreciate that the conception upon which this disclosure is based may readily be utilized as a basis for the designing of other structures, methods and systems for carrying out the several purposes (and others) of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which:

FIG. 1 exemplarily shows a high-level flow chart for a contribution evaluation method 100;

FIG. 2 exemplarily depicts an example of a federated learning scheme;

FIG. 3 exemplarily depicts a conventional reward structure for a client in a federated learning scheme;

FIGS. 4-5 exemplarily depict a system framework using the method 100 for a temporal policy implantation to a federated learning scheme;

FIG. 6 depicts a cloud computing node 10 according to an embodiment of the present invention;

FIG. 7 depicts a cloud computing environment 50 according to an embodiment of the present invention; and

FIG. 8 depicts abstraction model layers according to an embodiment of the present invention.

### DETAILED DESCRIPTION

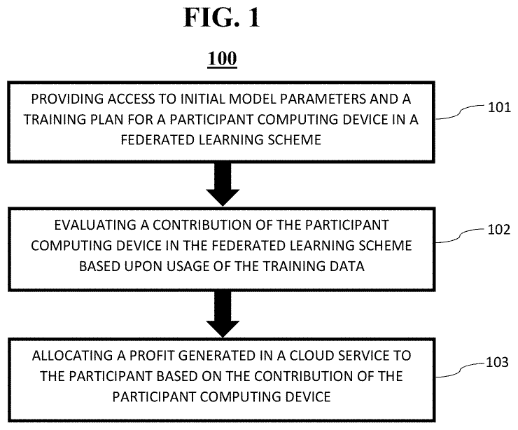

The invention will now be described with reference to FIG. 1-9, in which like reference numerals refer to like parts throughout. It is emphasized that, according to common practice, the various features of the drawing are not necessarily to scale. On the contrary, the dimensions of the various features can be arbitrarily expanded or reduced for clarity.

With reference now to the exemplary method 100 depicted in FIG. 1, the contribution evaluation method 100 includes various steps for a practical system solution to evaluate a contribution of participants in federated learning. The invention provides a general solution to quantitively measure the contribution of participants in federated learning and the solution can be applied to numerous applications including general federated learning scenarios for malicious participant detection and payment distribution in machine learning cloud service based on the participants' contributions in the federated learning.

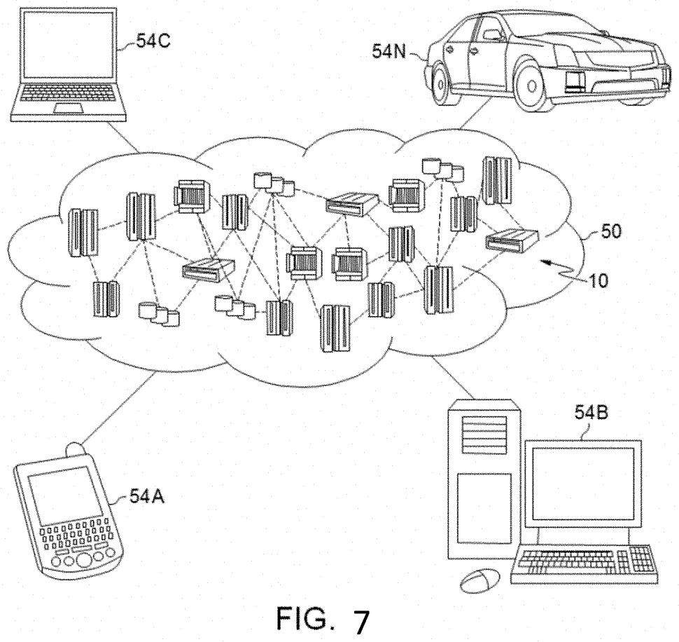

As shown in at least FIG. 7, one or more computers of a computer system 12 according to an embodiment of the present invention can include a memory 28 having instructions stored in a storage system to perform the steps of FIG. 1.

The contribution evaluation method 100 according to an embodiment of the present invention may act in a more sophisticated, useful and cognitive manner, giving the impression of cognitive mental abilities and processes related to knowledge, attention, memory, judgment and evaluation, reasoning, and advanced computation. A system can be said to be “cognitive” if it possesses macro-scale properties—perception, goal-oriented behavior, learning/memory and action—that characterize systems (i.e., humans) generally recognized as cognitive.

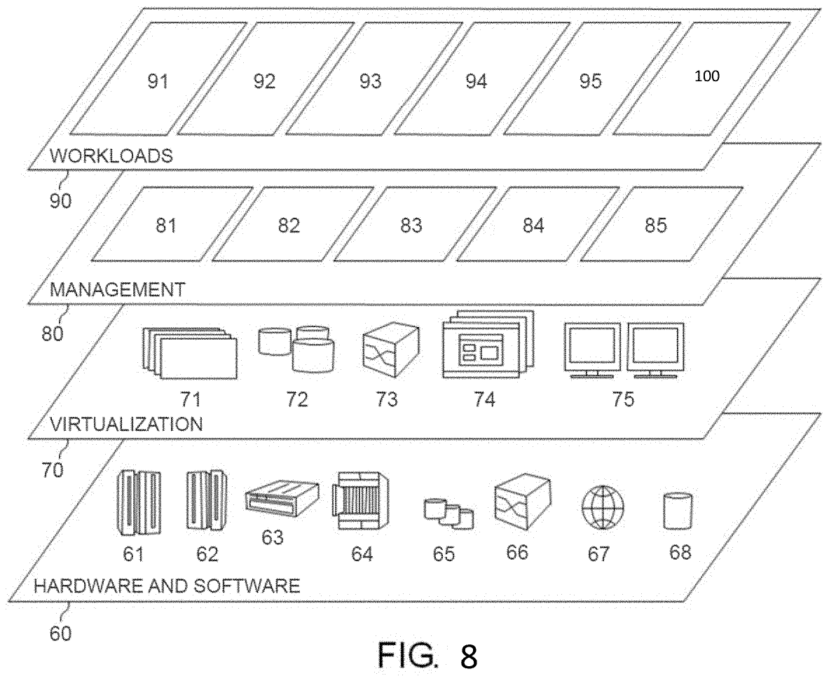

Although one or more embodiments (see e.g., FIGS. 7-9) may be implemented in a cloud environment 50 (see e.g., FIG. 8), it is nonetheless understood that the present invention can be implemented outside of the cloud environment.

With reference generally to FIGS. 1-5, the method 100 evaluates a contribution by a server side, only based on model updates from a participant('s) computing device (i.e., participant). The method 100 does not require participant(s) to submit any data information and measurement results on the data. This not only protects the data privacy of participant(s), but also limits the attack vectors from participant(s) compared with the conventional techniques, because the method does not need data information from participants, which could be manipulated by malicious participants. In federated learning scenario, all the participants will train the model locally with their own datasets. The invention can determine the contribution of a participant from the model updates received from the participant.

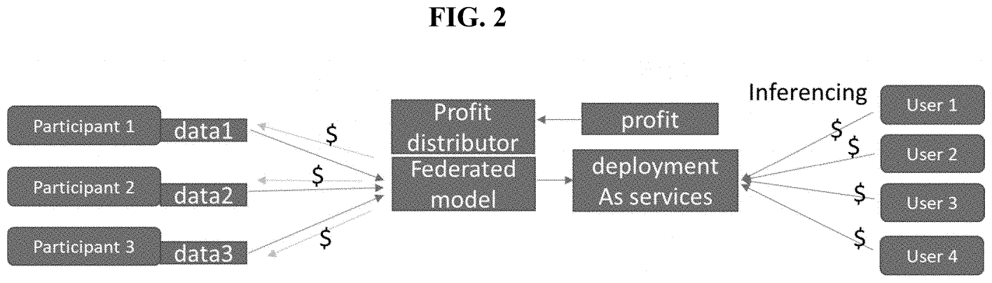

In federated learning, multiple participants collaborate to train a global machine learning model. Each participant uses their local dataset and computing resources. In many scenarios, there is a need to evaluate the contribution of each participant in the federated learning process. FIG. 2 exemplarily depicts the profit distribution for machine learning as a service. For example, a client server includes the profit distributer, the federated model, and the deployment as a service.

In the example depicted in FIG. 2, the participant(s) train the model and then user(s) use the model by inputting money in order to use the model. Once the user(s) input the money, the profit is calculated, and the invention determines how much of the profit to distribute to each participant via the method 100 described below. It is noted that the user(s) utilize the model via an application. The user(s) pay money in order to utilize the model via a payment accepting module of the application (e.g., credit card payment, subscription, token payment, etc.). The participant(s) train the model and the money input by the user(s) to use the trained model is then distributed as profit between participant(s).

The participant(s) may have data of varying quality and “dirty” data. Some participant(s) may negatively impact the model accuracy if they are involved. Identifying participant(s) of zero contribution can enable a filtering mechanism that excludes such participants.

That is, in step 101, the invention provides initial model parameters and a training plan to a participant-computing device in a federated learning scheme.

In step 102, a contribution of the participant-computing device in the federated learning scheme is evaluated based upon usage of the training data at participant-computing device (i.e., the data used in the training plan). The contribution is based on a contribution within a specific duration (i.e., phase(s)). The federated learning scheme can be divided into phases based on a uniform division, a user input, etc., as discussed further below.

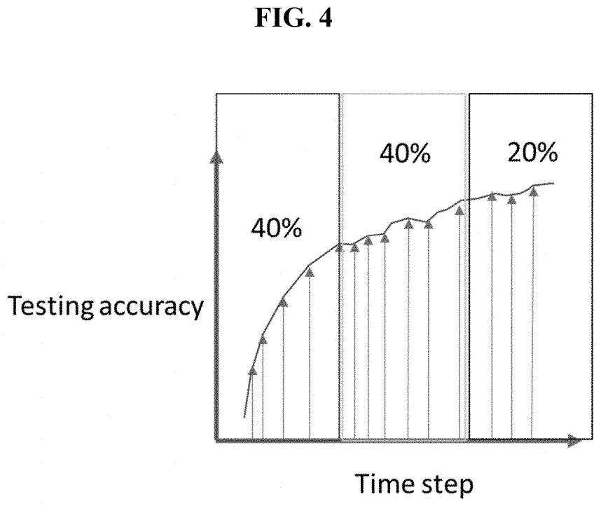

And, in step 103, a profit generated in a cloud service is allocated to the participant based on the contribution of the participant-computing device. The profit is equal to the contribution of the participant for the specific phase of the training for that percentage of the training (e.g., 40% of profit for first phase as shown in FIG. 4 is then split according to the contribution). As noted above with reference to FIG. 2, the profit is generated from the money input by user(s) that are using the model. The sum of all of the contributions of all of the participants adds up to 1 (i.e., a contribution is a fraction of 1).

The contribution and importance of participants can vary among different training phases in FL. Thus, the invention includes a solution for evaluating a contribution of participants to the model quality and uses that contribution (i.e., the varied contribution) to allocate profit generated in a cloud service to the participants that join the training process of an FL model. Using actual contribution advances the technology to profit allocation for different phases.

The approach used in steps 101-103 can be applied to the online scenario of federated learning, in which participants intermittently join the learning process with newly generated or collected data. The model is being trained consistently, and the contribution and importance of each participant could vary during different training phases. Therefore, a temporal-aware solution is necessary, that allows different profit allocation during different phases, and evaluates the contribution dynamically based on each round of model updates.

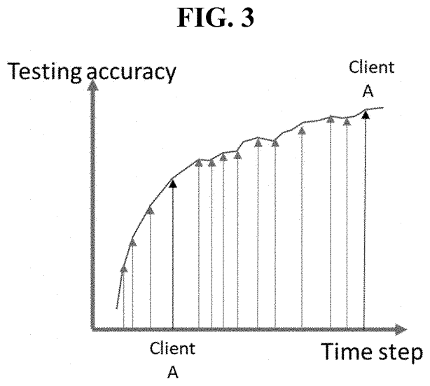

The method 100 calculates the contribution based on the model updates received from participants every round in a single federated model training process (e.g., does not require N times training of FL to compute contribution). In doing so, the invention includes a temporal-aware profit allocation that allows different profit policy among different training phases in a training process. For example, as shown in FIGS. 3-5, the contribution is divided into time steps across phases. Temporal-aware profit allocation policy is an improvement to adapt the profit allocation to different phases.

More specifically, the invention includes a global parameter (e.g., central) server that performs profiling of participants' contribution during a training process or after training with recording all historical updates from clients.

The issue is deciding a metric of allocation of profit (i.e., a profit allocation model). For example, if there is one unit of profit earned for the final global model, the invention determines how to distribute the unit of profit to participants that participate in the FL. To do this, steps 101-103 use a temporal-aware allocation which divides the training time into different durations (e.g., as shown in FIGS. 3-5), decides the profit allocation policy among different durations, computes the contribution score of a client in each duration, and sums the contribution scores of different durations for each client.

As shown in FIGS. 3-4, testing accuracy vs. a time step is shown for a the central server with benchmark testing data D, a value function of V(D, Mₜ) where Mₜ is the global model parameter at time step t (i.e., V can be the testing accuracy of Mₜ on D). The invention creates a temporal policy for profit allocation ratio.

To do so, the invention divides the time steps into different durations. The different durations can be based on approximate linear improvement, such as exponential improvement (first 40% of FIG. 4), linear improvement (second 40% of FIG. 4), and sub-linear improvement (last 20% of FIG. 4). The reason being is that the most computing power goes into the first two phases, such that more of the profit (i.e., 80% total) is (and should be) allocated to these two phases. The sub-linear phase is merely fine-tuning, such that only 20% of the profit is allocated to this phase.

Alternatively, a user-defined ratio for each duration can include an allocation ratio that varies for a uniform division, a higher ratio to an initial stage to encourage more participants to bootstrap a model, or higher ratio to a converging stage to attract more participants to approach a better accuracy.

FIG. 4 exemplary shows a user-defined ratio where 40% of profit is in the initial stages, 40% of the profit is in the middle stages to encourage participants to stay in the model, and only 20% of the profit are allocated to the end of the model since accuracy is not improved as much with further participation by the participants.

In each of the durations that are segments of the entire FL, a contribution score is computed for each participant individual to that participant. In each duration, an allocation ratio for that duration is also decided.

For example, a linear sum of model accuracy improvement of each time step with only applying updates from one client can be used.

To measure the data contribution within a duration, the central server evaluates the contribution of each participant with its test data T. The contribution is evaluated by the central server, given the model updates that the central server receives from the participant as input. In every k rounds (where k is greater than or equal to “1”), the central server performs a snapshot M on the current global model at the beginning of a first round of k before aggregation and updates and records a testing accuracy (A₍ₜ₋₁₎). It is noted that k is greater than or equal to “1” to smooth an impact of the client update. In some embodiments, k can be any value greater than “0” if desired.

Then, the central server records the updates from each participant received each round and at the end of k rounds, for each participant i, applies the participants' series of updates on model snapshot M to get model Mᵢ. The invention evaluates the model accuracy Aₜⁱ of each Mᵢ on test data and the contribution is scored for each participant i as Aₜⁱ−Aₜ₋₁.

Then, as described in step 102, the sum of the contribution score for each participant is computed, an in-duration ratio is computed as

$$( \frac{\text{each participants’s sum score}}{\text{sum all participant’s sum score}} ) ,$$

and the (sum all participant's sum score overall ratio is computed as the (duration ratio×in-duration ratio).

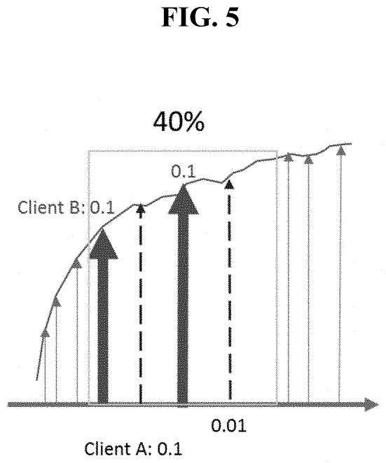

For example, as shown in FIG. 5, the contribution of participant A is 0.1 and 0.01, which has a sum score for participant A as 0.11 (participant A (client A) being indicated by the dashed arrows). The contribution of participant B is 0.1 and 0.1 for a sum score of 0.2 (participant B (client B) being indicated by the thick solid arrows).

The in-duration ratio for participant A is

$$( \frac{0.11}{( 0.11 + 0.2 )} ) = \text{.355}$$

such that an overall ratio is 0.355*40%. Meaning, participant A receives 0.355 of the profit for the 40% allocation based on the temporal split of the FL.

Again, the client server is able to determine the contribution score for participant A only from the update that is sent from the participant(s) (e.g., in this case participant A and participant B) to the client server and does not require extra data.

Thus, the method 100 calculates the contribution of each participant more efficiently and has lower computation and communication costs, since the method does not require N times training of federated learning to compute the contribution of each participant. The contribution and importance of participants can vary among different training phases in FL and the method 100 solves this problem. The temporal-aware profit allocation policy is necessary to adapt the profit allocation to different phases.

The method 100 can be applied to general federated learning scenarios for malicious participant detection and profit allocation in ML cloud service based on the participants' contributions in FL by quantitatively evaluating the contribution of each participant for profit allocation.

Exemplary Aspects, Using a Cloud Computing Environment

Although this detailed description includes an exemplary embodiment of the present invention in a cloud computing environment, it is to be understood that implementation of the teachings recited herein are not limited to such a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client circuits through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

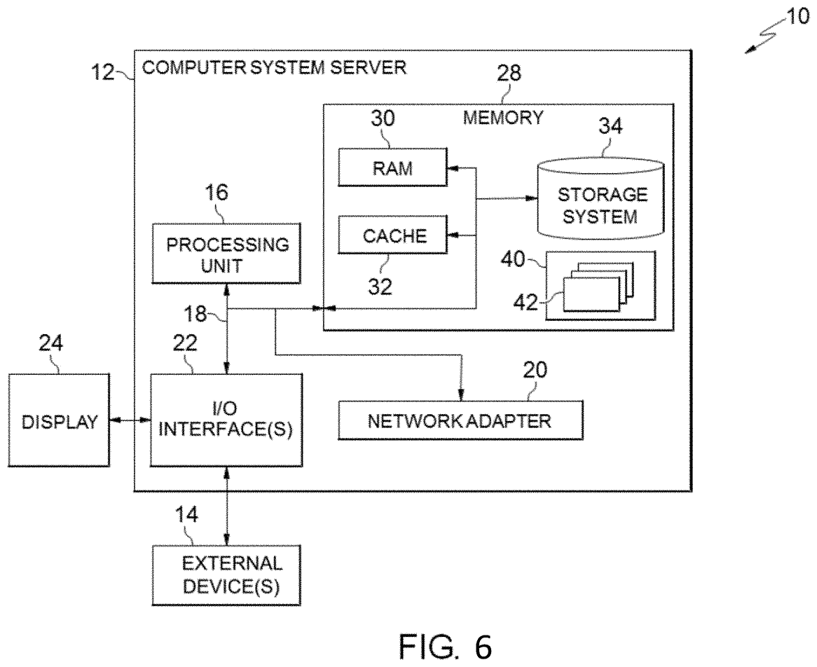

Referring now to FIG. 6, a schematic of an example of a cloud computing node is shown. Cloud computing node 10 is only one example of a suitable node and is not intended to suggest any limitation as to the scope of use or functionality of embodiments of the invention described herein. Regardless, cloud computing node 10 is capable of being implemented and/or performing any of the functionality set forth herein.

Although cloud computing node 10 is depicted as a computer system/server 12, it is understood to be operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

Referring again to FIG. 6, computer system/server 12 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external circuits 14 such as a keyboard, a pointing circuit, a display 24, etc.; one or more circuits that enable a user to interact with computer system/server 12; and/or any circuits (e.g., network card, modem, etc.) that enable computer system/server 12 to communicate with one or more other computing circuits. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, circuit drivers, redundant processing units, external disk drive arrays, RAID systems, tape drives, and data archival storage systems, etc.

Referring now to FIG. 7, illustrative cloud computing environment 50 is depicted. As shown, cloud computing environment 50 comprises one or more cloud computing nodes 10 with which local computing circuits used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing circuit. It is understood that the types of computing circuits 54A-N shown in FIG. 7 are intended to be illustrative only and that computing nodes 10 and cloud computing environment 50 can communicate with any type of computerized circuit over any type of network and/or network addressable connection (e.g., using a web browser).

Referring now to FIG. 8, an exemplary set of functional abstraction layers provided by cloud computing environment 50 (FIG. 7) is shown. It should be understood in advance that the components, layers, and functions shown in FIG. 8 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage circuits 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and, more particularly relative to the present invention, the contribution evaluation method 100.

The present invention may be a system, a method, and/or a computer program product at any possible technical detail level of integration. The contribution evaluation computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A computer-implemented contribution evaluation method, the method comprising:
providing access to an initial model parameter and a training plan for a participant computing device in a federated learning scheme; and
evaluating a contribution of the participant-computing device in the federated learning scheme based upon usage of the training data in the training plan.

2. The computer-implemented contribution evaluation method of claim 1, further comprising allocating a profit generated in a cloud service to the participant-computing device based on the contribution of the participant-computing device.

3. The computer-implemented contribution evaluation method of claim 1, wherein the contribution is related to an improvement in a quality of a model provided by the participant-computing device.

4. The computer-implemented contribution evaluation method of claim 1, wherein the federated learning scheme is split into phases and the contribution is evaluated with respect to each phase of the phases.

5. The computer-implemented contribution evaluation method of claim 1, wherein the contribution of the participant-computing device is computed based on only a model update sent from the participant-computing device.

6. The computer-implemented contribution evaluation method of claim 4, wherein the phases are split according to a user-defined ratio.

7. The computer-implemented contribution evaluation method of claim 1, embodied in a cloud-computing environment.

8. A contribution evaluation computer program product, the contribution evaluation computer program product comprising a computer-readable storage medium having program instructions embodied therewith, the program instructions executable by a computer to cause the computer to perform:
providing access to an initial model parameter and a training plan for a participant computing device in a federated learning scheme; and
evaluating a contribution of the participant-computing device in the federated learning scheme based upon usage of the training data in the training plan.

9. The contribution evaluation computer program product of claim 8, further comprising allocating a profit generated in a cloud service to the participant-computing device based on the contribution of the participant-computing device.

10. The contribution evaluation computer program product of claim 8, wherein the contribution is related to an improvement in a quality of a model provided by the participant-computing device.

11. The contribution evaluation computer program product of claim 8, wherein the federated learning scheme is split into phases and the contribution is evaluated with respect to each phase of the phases.

12. The contribution evaluation computer program product of claim 8, wherein the contribution of the participant-computing device is computed based on only a model update sent from the participant-computing device.

13. The contribution evaluation computer program product of claim 11, wherein the phases are split according to a user-defined ratio.

14. A contribution evaluation system, said system comprising:
a processor; and
a memory, the memory storing instructions to cause the processor to perform:
providing access to an initial model parameter and a training plan for a participant computing device in a federated learning scheme; and
evaluating a contribution of the participant-computing device in the federated learning scheme based upon usage of the training data in the training plan.

15. The contribution evaluation system of claim 14, further comprising allocating a profit generated in a cloud service to the participant-computing device based on the contribution of the participant-computing device.

16. The contribution evaluation system of claim 14, wherein the contribution is related to an improvement in a quality of a model provided by the participant-computing device.

17. The contribution evaluation system of claim 14, wherein the federated learning scheme is split into phases and the contribution is evaluated with respect to each phase of the phases.

18. The contribution evaluation system of claim 14, wherein the contribution of the participant-computing device is computed based on only a model update sent from the participant-computing device.

19. The contribution evaluation system of claim 17, wherein the phases are split according to a user-defined ratio.

20. The contribution evaluation system of claim 19, embodied in a cloud-computing environment.
